(19) United States
(12) Patent Application Publication
(10) Pub. No.: US 2026/0267091 A1
(43) Pub. Date: Sep. 10, 2026

(54) OPTICAL MODULE

(71) Applicant: HISENSE BROADBAND MULTIMEDIA TECHNOLOGIES CO., LTD., Qingdao (CN)

(72) Inventors: Zuquan CHEN, Qingdao (CN); Xujie HUANG, Qingdao (CN); Jianwei MU, Qingdao (CN); Xinnan WANG, Qingdao (CN)

(21) Appl. No.: 19/658,406

(22) Filed: Apr. 24, 2026

Related U.S. Application Data
(63) Continuation of application No. PCT/CN2024/082011, filed on Mar. 15, 2024.

(30) Foreign Application Priority Data
Oct. 26, 2023 (CN) 202311402916.5
Oct. 26, 2023 (CN) 202322884644.9

(51) Int. Cl. G02B 6/42

(52) U.S. Cl. CPC G02B 6/4214; G02B 6/428

(57) ABSTRACT

An optical module including a circuit board that is formed thereon with a notch, an optical transmitter component and an optical receiver component. The optical transmitter component includes a tube housing overlapping on the notch and an electrical connector disposed at an end of the tube housing. One end of the electrical connector extends into the tube housing, and the other end is provided with a boss. A first connecting portion is formed on a sidewall of the notch, and a second connecting portion is formed on an end surface of the boss facing the circuit board. The first connecting portion is interlockingly engaged with the second connecting portion to achieve a relatively fixed connection between them. The optical receiver component includes converging and reflecting components, whose curved surfaces are configured to reflect optical signals output from the optical fiber array and converge the reflected optical signals.

This disclosure is a continuation of International Application No. PCT/CN2024/082011, filed on Mar. 15, 2024, which claims priority to Chinese Patent Application No. 202311402916.5, filed with the China National Intellectual Property Administration on Oct. 26, 2023, and to Chinese Patent Application No. 202322884644.9, filed with the China National Intellectual Property Administration on Oct. 26, 2023. All of the above-mentioned applications are incorporated herein by reference in their entirety.

### FIELD OF THE INVENTION

The present disclosure relates to the field of optical fiber communication technology, and in particular, to an optical module.

### BACKGROUND OF THE INVENTION

With the development of new services and application models such as cloud computing, mobile Internet, and video, advances in optical communication technology have become increasingly important. In optical communication technology, the optical module, as one of the key devices in optical communication equipment, enables the conversion between optical and electrical signals. During the development of optical communication technology, there is demand for the data transmission rate of optical modules to continuously increase.

### SUMMARY OF THE INVENTION

The present disclosure provides an optical module, including:
a circuit board, where a notch is formed on a surface of the circuit board, and a first connecting portion is formed on a sidewall of the notch;
an optical transmitter component, including:
a tube housing, overlapping on a surface of the notch; and
an electrical connector, disposed at an end of the tube housing, where one end of the electrical connector extends into the tube housing, the other end of the electrical connector is provided with a boss, the boss is located outside the tube housing, a first metal region and a second metal region are respectively formed on an upper surface and a lower surface of the boss, the first metal region is flush with an upper surface of the circuit board, the second metal region is flush with a lower surface of the circuit board, the first metal region is wire-bonded to the upper surface of the circuit board, the second metal region is wire-bonded to the lower surface of the circuit board, a second connecting portion is formed on an end surface of the boss facing the circuit board, and the second connecting portion is interlockingly engaged with the first connecting portion to achieve a relatively fixed connection between the electrical connector and the circuit board; and
an optical receiver component, disposed on the surface of the circuit board, and including:
an optical fiber array, including several receiving optical fibers, and configured to receive multiple optical signals; and
a converging and reflecting component array, disposed on one side of the optical fiber array, and including several converging and reflecting components, where one of the converging and reflecting components corresponds to one of the receiving optical fibers, curved surfaces are formed on surfaces of the converging and reflecting components, the curved surfaces are recessed relative to a light output end surface of the optical fiber array, and the curved surfaces are configured to reflect the optical signals output from the optical fiber array and converge the reflected optical signals.

### BRIEF DESCRIPTION OF THE DRAWINGS

To more clearly illustrate the technical solutions in the embodiments of the present disclosure, the accompanying drawings that need to be used in the description of the embodiments or the prior art will be briefly introduced below. Apparently, the accompanying drawings in the description below merely illustrate some embodiments of the present disclosure. Those of ordinary skill in the art may also derive other accompanying drawings from these accompanying drawings without creative efforts.

FIG. 1 is a partial architecture diagram of an optical communication system according to some embodiments of the present disclosure;

FIG. 2 is a partial structural diagram of a host computer according to some embodiments of the present disclosure;

FIG. 3 is a structural diagram of an optical module according to some embodiments of the present disclosure;

FIG. 4 is an exploded view of an optical module according to some embodiments of the present disclosure;

FIG. 5 is a first internal structural diagram of an optical module according to some embodiments of the present disclosure;

FIG. 6 is a second internal structural diagram of an optical module according to some embodiments of the present disclosure;

FIG. 7 is a first assembly diagram of an optical receiver component and a circuit board according to some embodiments of the present disclosure;

FIG. 8 is a first structural diagram of an optical receiver component according to some embodiments of the present disclosure;

FIG. 9 is a second assembly diagram of an optical receiver component and a circuit board according to some embodiments of the present disclosure;

FIG. 10 is a second structural diagram of an optical receiver component according to some embodiments of the present disclosure;

FIG. 11 is a schematic diagram of an optical path of an optical receiver component according to some embodiments of the present disclosure;

FIG. 12 is a schematic principle diagram of an optical path of a converging and reflecting component according to some embodiments of the present disclosure;

FIG. 13 is a structural diagram of a support frame according to some embodiments of the present disclosure;

FIG. 14 is a structural diagram of a converging and reflecting component according to some embodiments of the present disclosure;

FIG. 15 is a structural diagram of an optical transmitter component according to some embodiments of the present disclosure;

FIG. 16 is an exploded view of an optical transmitter component in an optical module according to some embodiments of the present disclosure;

FIG. 17 is a schematic assembly diagram of an optical transmitter component and a circuit board according to some embodiments of the present disclosure;

FIG. 18 is a schematic structural diagram of a circuit board according to some embodiments of the present disclosure;

FIG. 19 is a first structural diagram of an electrical connector according to some embodiments of the present disclosure;

FIG. 20 is a second structural diagram of an electrical connector according to some embodiments of the present disclosure;

FIG. 21 is a schematic cross-sectional view of a circuit board according to some embodiments of the present disclosure;

FIG. 22 is an assembly cross-sectional view of an optical transmitter component and a circuit board according to some embodiments of the present disclosure;

FIG. 23 is a schematic diagram of a bonding wire between an electrical connector and a circuit board according to some embodiments of the present disclosure;

FIG. 24 is an assembly diagram of a first protective cover and a second protective cover according to some embodiments of the present disclosure;

FIG. 25 is a cross-sectional view of a first protective cover and a second protective cover according to some embodiments of the present disclosure; and

FIG. 26 is an exploded view of a first protective cover and a second protective cover according to some embodiments of the present disclosure.

### DETAILED DESCRIPTION OF THE EMBODIMENTS

The technical solutions in some embodiments of the present disclosure will be clearly and completely described below with reference to the accompanying drawings. Apparently, the described embodiments are merely some rather than all of the embodiments of the present disclosure. All other embodiments obtained by those of ordinary skill in the art based on the embodiments provided in the present disclosure fall within the scope of protection of the present disclosure.

Unless the context requires otherwise, throughout the description and claims, the term “comprise” and other forms thereof, such as the third-person singular form “comprises” and the present participle form “comprising” are construed in an open, inclusive meaning, that is, “comprising, but not limited to.” In the description, the terms “one embodiment,” “some embodiments,” “exemplary embodiments,” “example,” “specific example,” or “some examples,” etc. are intended to indicate that a particular feature, structure, material, or characteristic related to the embodiment or example is included in at least one embodiment or example of the present disclosure. The schematic illustration of the above terms does not necessarily refer to the same embodiment or example. Furthermore, the specific features, structures, materials, or characteristics described may be included in any one or more embodiments or examples in any suitable manner.

Hereinafter, the terms “first” and “second” are for descriptive purposes only, and are not to be understood as indicating or implying relative importance or as implicitly indicating the number of technical features indicated. Thus, features defined with “first” and “second” may explicitly or implicitly include one or more of such features. In the description of the embodiments of the present disclosure, unless otherwise specified, “a plurality of” means two or more.

In describing some embodiments, the expressions “coupled” and “connected” and extensions thereof may be used. For example, in describing some embodiments, the term “connected” may be used to indicate that two or more components are in direct physical contact or electrical contact with each other. For another example, in describing some embodiments, the term “coupled” may be used to indicate that two or more components are in direct physical contact or electrical contact with each other. However, the term “coupled” or “communicatively coupled” may also indicate that two or more components are not in direct contact with each other, but still cooperate or interact with each other. The embodiments disclosed herein are not necessarily limited to the contents herein.

“At least one of A, B, and C” has the same meaning as “at least one of A, B, or C,” encompassing the following combinations of A, B, and C: only A, only B, only C, a combination of A and B, a combination of A and C, a combination of B and C, and a combination of A, B, and C.

“A and/or B” includes three combinations of only A, only B, and a combination of A and B.

The use of “suitable for” or “configured to” herein means open and inclusive language that does not exclude devices suitable for or configured to perform additional tasks or steps.

As used herein, “about,” “approximately,” or “approximately” includes a stated value as well as an average within an acceptable range of deviation from a particular value, where the acceptable range of deviation is determined by one of ordinary skill in the art taking into account the measurement in question and the error associated with the measurement of a particular amount (i.e., limitations of the measurement system).

In optical communication technology, to establish information transmission between information processing devices, it is necessary to load information onto light and use the propagation of light to achieve the transmission of information. Here, the light loaded with information is an optical signal. When the optical signal is transmitted in the information transmission devices, the loss of optical power can be reduced, such that high-speed, long-distance, and low-cost information transmission can be achieved. The signals that the information processing devices are able to recognize and process are electrical signals. The information processing devices usually include optical network units (ONUs), gateways, routers, switches, mobile phones, computers, servers, tablet computers, televisions, etc. The information transmission devices usually include optical fibers and optical waveguides.

The optical modules enable the conversion between optical signals and electrical signals from the information processing devices and the information transmission devices. For example, at least one of an optical signal input or an optical signal output of an optical module is connected to an optical fiber, and at least one of an electrical signal input or an electrical signal output of the optical module is connected to an optical network unit; a first optical signal from the optical fiber is transmitted to the optical module, and the optical module converts the first optical signal into a first electrical signal and transmits the first electrical signal to the optical network unit; and a second electrical signal from the optical network unit is transmitted to the optical module, and the optical module converts the second electrical signal into a second optical signal and transmits the second optical signal to the optical fiber. Since information can be transmitted through electrical signals between a plurality of information processing devices, at least one information processing device in the plurality of information processing devices is required to be directly connected to the optical module, and all information processing devices are not required to be directly connected to the optical module. Here, the information processing device directly connected to the optical module is referred to as a host computer of the optical module. In addition, the optical signal input or the optical signal output of the optical module can be referred to as an optical port, and the electrical signal input or the electrical signal output of the optical module can be referred to as an electrical port.

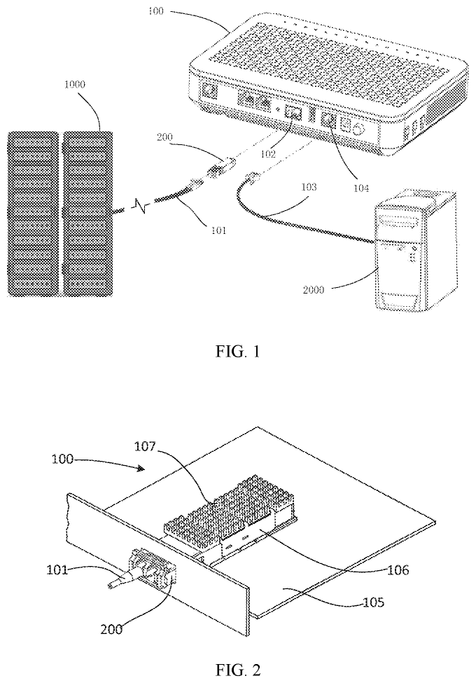

FIG. 1 is a partial structural diagram of an optical communication system according to some embodiments of the present disclosure. As shown in FIG. 1, the optical communication system primarily includes a remote information processing device 1000, a local information processing device 2000, a host computer 100, an optical module 200, an optical fiber 101, and a network cable 103.

One end of the optical fiber 101 extends toward the remote information processing device 1000, and the other end of the optical fiber 101 is connected to the optical module 200 via an optical port of the optical module 200. An optical signal can undergo total reflection in the optical fiber 101, and the propagation of the optical signal in the total reflection direction can nearly maintain its original optical power. The optical signal undergoes multiple total reflections in the optical fiber 101 to transmit an optical signal from the remote information processing device 1000 to the optical module 200 or to transmit an optical signal from the optical module 200 to the remote information processing device 1000, thereby achieving long-distance and low-power-loss information transmission.

The optical communication system may include one or more optical fibers 101, and the optical fiber 101 is detachably or fixedly connected to the optical module 200. The host computer 100 is configured to provide a data signal to the optical module 200, receive a data signal from the optical module 200, or monitor or control an operating state of the optical module 200.

The host computer 100 includes a generally cuboid-shaped housing and an optical module interface 102 disposed on the housing. The optical module interface 102 is configured to be connected to the optical module 200, enabling the host computer 100 to establish a one-way or two-way electrical signal connection with the optical module 200.

The host computer 100 further includes an external electrical interface that can be connected to an electrical signal network. For example, the external electrical interface includes a universal serial bus (USB) interface or a network cable interface 104. The network cable interface 104 is configured to be connected to the network cable 103, enabling the host computer 100 to establish a one-way or two-way electrical signal connection with the network cable 103. One end of the network cable 103 is connected to the local information processing device 2000, and the other end of the network cable 103 is connected to the host computer 100, thereby establishing an electrical signal connection between the local information processing device 2000 and the host computer 100 via the network cable 103. For example, a third electrical signal sent by the local information processing device 2000 is transmitted into the host computer 100 via the network cable 103. The host computer 100 generates a second electrical signal based on the third electrical signal. The second electrical signal from the host computer 100 is transmitted to the optical module 200. The optical module 200 converts the second electrical signal into a second optical signal and transmits the second optical signal to the optical fiber 101. The second optical signal is transmitted through the optical fiber 101 to the remote information processing device 1000. For example, a first optical signal from the remote information processing device 1000 is transmitted through the optical fiber 101. The first optical signal from the optical fiber 101 is transmitted to the optical module 200. The optical module 200 converts the first optical signal into a first electrical signal, and then the optical module 200 transmits the first electrical signal to the host computer 100. The host computer 100 generates a fourth electrical signal based on the first electrical signal and transmits the fourth electrical signal to the local information processing device 2000. It should be noted that the optical module is a tool to achieve the conversion between optical signals and electrical signals. During the conversion between the optical signals and the electrical signals, the information remains unchanged, and the encoding and decoding methods for the information may vary.

In addition to the optical network unit, the host computer 100 further includes an optical line terminal (OLT), an optical network terminal (ONT), or a data center server.

FIG. 2 is a partial structural diagram of a host computer according to some embodiments of the present disclosure. To clearly show the connection relationship between the optical module 200 and the host computer 100, FIG. 2 shows only the structure of the host computer 100 related to the optical module 200. As shown in FIG. 2, the host computer 100 further includes a printed circuit board (PCB) 105 disposed in the housing, a cage 106 disposed on a surface of the PCB 105, a heat sink 107 disposed on the cage 106, and an electrical connector disposed inside the cage 106. The electrical connector is configured to be connected to the electrical port of the optical module 200. The heat sink 107 has protruding structures such as fins that enlarge the heat dissipation area.

The optical module 200 is inserted into the cage 106 of the host computer 100, and the optical module 200 is fixed by the cage 106. The heat generated by the optical module 200 is conducted to the cage 106 and then diffused through the heat sink 107. After the optical module 200 is inserted into the cage 106, the electrical port of the optical module 200 is connected to the electrical connector inside the cage 106, such that the optical module 200 establishes a two-way electrical signal connection with the host computer 100. In addition, the optical port of the optical module 200 is connected to the optical fiber 101, such that the optical module 200 establishes a two-way optical signal connection with the optical fiber 101.

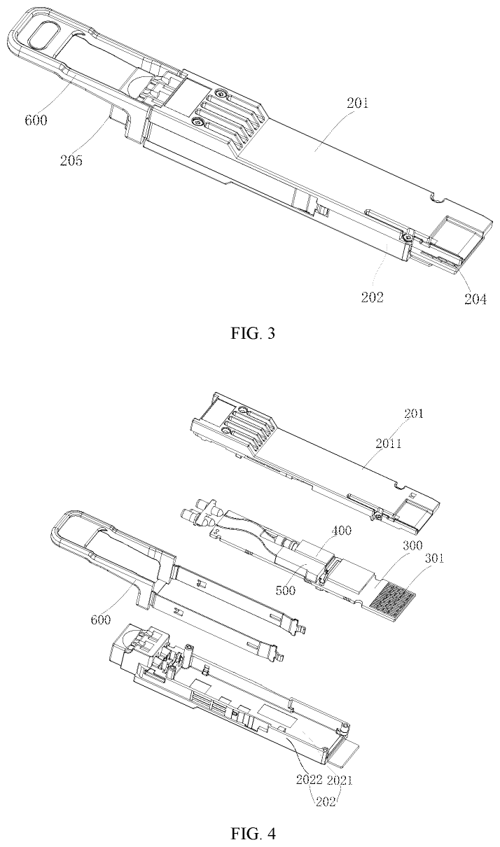

FIG. 3 is a structural diagram of an optical module according to some embodiments of the present disclosure. FIG. 4 is an exploded view of an optical module according to some embodiments of the present disclosure. As shown in FIG. 3 and FIG. 4, the optical module 200 includes a shell, and a circuit board 300, an optical transmitter component 400 and an optical receiver component 500 disposed in the shell. However, the present disclosure is not limited to this. In some embodiments, the optical module 200 includes either an optical transmitter component 400 or an optical receiver component 500.

The shell includes an upper shell 201 and a lower shell 202. The upper shell 201 covers the lower shell 202 to form the shell with an opening 204 and an opening 205. The outer contour of the shell is generally square.

In some embodiments, the lower shell 202 includes a bottom plate 2021 and two lower side plates 2022 located on two sides of the bottom plate 2021 and perpendicular to the bottom plate 2021; and the upper shell 201 includes a cover plate 2011. The cover plate 2011 covers the two lower side plates 2022 of the lower shell 202 to form the shell.

In some embodiments, the lower shell 202 includes a bottom plate 2021 and two lower side plates 2022 located on two sides of the base plate 2021 and perpendicular to the bottom plate 2021; and the upper shell 201 includes a cover plate 2011 and two upper side plates located on two sides of the cover plate 2011 and perpendicular to the cover plate 2011. The two upper side plates and the two lower side plates 2022 are combined to ensure that the upper shell 201 covers the lower shell 202.

The direction of a line connecting the opening 204 to the opening 205 may be consistent or inconsistent with the length direction of the optical module 200. For example, the opening 204 is located at an end of the optical module 200 (the right end in FIG. 3), and the opening 205 is also located at an end of the optical module 200 (the left end in FIG. 3). Alternatively, the opening 204 is located at an end of the optical module 200, and the opening 205 is located on a side of the optical module 200. The opening 204 is an electrical port. A gold finger 301 of the circuit board 300 extends from the opening 204 and is inserted into the electrical connector of the host computer 100. The opening 205 is an optical port configured to be connected to the external optical fiber 101, such that the optical fiber 101 connects the optical transmitter component 400 and the optical receiver component 500 in the optical module 200.

An assembly method for combining the upper shell 201 with the lower shell 202 is adopted, such that the circuit board 300, the optical transmitter component 400, the optical receiver component 500, and other components can be conveniently mounted in the shell. These components can be encapsulated and protected by the upper shell 201 and lower shell 202. In addition, when the circuit board 300, the optical transmitter component 400, the optical receiver component 500, and other components are assembled, the deployment of positioning components, heat dissipation components, and electromagnetic shielding components of these components is facilitated, which is conducive to automated production.

In some embodiments, the upper shell 201 and the lower shell 202 are made of metal, which is conducive to electromagnetic shielding and heat dissipation.

In some embodiments, the optical module 200 further includes an unlocking component 600 located outside its shell. The unlocking component 600 is configured to achieve a fixed connection between the optical module 200 and the host computer, or to release the fixed connection between the optical module 200 and the host computer.

For example, the unlocking component 600 is located outside the two lower side plates 2022 of the lower shell 202, and includes an engaging component that matches the cage 106 of the host computer 100. When the optical module 200 is inserted into the cage 106, the optical module 200 is fixed in the cage 106 by the engaging component of the unlocking component 600. When the unlocking component 600 is pulled, the engaging component of the unlocking component 600 moves accordingly, thereby changing the connection relationship between the engaging component and the host computer to release the fixation between the optical module 200 and the host computer, such that the optical module 200 can be withdrawn from the cage 106.

The circuit board 300 includes circuit traces, electronic components, and chips. The electronic components and the chips are connected according to the circuit design through the circuit traces to implement the functions such as power supply, electrical signal transmission, and grounding. The electronic components may include, for example, capacitors, resistors, transistors, and metal-oxide-semiconductor field-effect transistors (MOSFETs). The chips may include, for example, microcontroller units (MCUs), laser driving chips, transimpedance amplifiers (TIAs), limiting amplifiers, clock and data recovery (CDR) chips, power management chips, and digital signal processing (DSP) chips.

The circuit board 300 is generally a rigid circuit board. The rigid circuit board can also serve a load-bearing function due to its relatively rigid material, for example, the rigid circuit board can smoothly carry the aforementioned electronic components and chips. The rigid circuit board can also be inserted into the electrical connector in the cage 106 of the host computer 100.

The circuit board 300 further includes a gold finger 301 formed on an end surface thereof. The gold finger 301 is composed of a plurality of mutually independent pins. The circuit board 300 is inserted into the cage 106, and the gold finger 301 is connected to the electrical connector in the cage 106. The gold finger 301 may be disposed on only one surface of the circuit board 300 (e.g., the upper surface shown in FIG. 4), or may be disposed on the upper and lower surfaces of the circuit board 300 to provide more pins, thereby adapting to scenarios requiring a large number of pins. The gold finger 301 is configured to establish an electrical connection with the host computer to achieve power supply, grounding, two-wire inter-integrated circuit (I2C) signal transmission, data signal transmission, etc. Certainly, flexible circuit boards are also used in some optical modules. Flexible circuit boards are generally used in conjunction with rigid circuit boards as a supplement to rigid circuit boards.

At least one of the optical transmitter component 400 or the optical receiver component 500 is located on one side of the circuit board 300 away from the gold finger 301.

In some embodiments, the optical transmitter component 400 and the optical receiver component 500 are physically separated from the circuit board 300 and are then electrically connected to the circuit board 300 via corresponding flexible circuit boards or electrical connectors.

In some embodiments, at least one of the optical transmitter component or the optical receiver component may be directly disposed on the circuit board 300. For example, at least one of the optical transmitter component or the optical receiver component may be disposed on a surface or a side edge of the circuit board 300.

FIG. 5 is a first internal structural diagram of an optical module according to some embodiments of the present disclosure. As shown in FIG. 5, in some embodiments, the optical transmitter component 400 and the optical receiver component 500 are respectively located on two sides of the circuit board 300. The optical transmitter component 400 includes a cover plate 401 and a tube housing 402. The optical transmitter component 400 includes a first optical fiber adapter connected to the optical fiber, through which an optical emission signal generated by the optical transmitter component 400 is transmitted.

In some embodiments of the present disclosure, the optical receiver component 500 includes a second optical fiber adapter 503. The second optical fiber adapter 503 is also connected to the optical fiber to receive an optical reception signal transmitted from the outside. The optical receiver component 500 includes an optical demultiplexing assembly 504, a converging lens array 505, a reflecting mirror 506, and an optical receiver chip array 507. The optical demultiplexing assembly 504 decomposes an optical signal output from the second optical fiber adapter 503 into multiple optical signals. The converging lens array 505 includes a plurality of converging lenses. One converging lens corresponds to one optical signal. The optical signal is converged by the converging lens. The photosensitive surface of the optical receiver chip array 507 is parallel to the circuit board 300, that is, the transmission direction of the optical signals received by the optical receiver chip array 507 is perpendicular to the circuit board 300, while the transmission direction of the optical signal output from the converging lens is parallel to the circuit board 300. Therefore, the reflecting mirror 506 is disposed above the optical receiver chip array 507 in the light output direction of the converging lens array 505. The reflecting mirror 506 is configured to reflect the optical signals output from the converging lens array 505 toward the optical receiver chip array 507, such that the transmission direction of the optical signals is adjusted from parallel to the surface of the circuit board 300 to perpendicular to the surface of the circuit board 300, thereby transmitting the optical signals into the optical receiver chip array 507, and achieving reception of the optical signals.

In some embodiments, since the reflecting mirror 506 needs to be disposed above the optical receiver chip array 507, and the optical receiver chip array 507 is located on the surface of the circuit board 300, a substrate 502 is further disposed on the surface of the circuit board 300. The optical demultiplexing assembly 504, the converging lens array 505, and the reflecting mirror 506 are disposed on a surface of the substrate 502, such that the light incident surfaces of the optical demultiplexing assembly 504, the converging lens array 505, and the reflecting mirror 506 are located on the same horizontal plane, and it can be ensured that the reflecting mirror 506 has a certain distance from the optical receiver chip array 507 located therebelow.

In some embodiments, the optical receiver component 500 further includes a cover 501. The cover 501 covers the surfaces of the optical demultiplexing assembly 504, the converging lens array 505, the reflecting mirror 506, and the optical receiver chip array 507, thereby protecting these optical components.

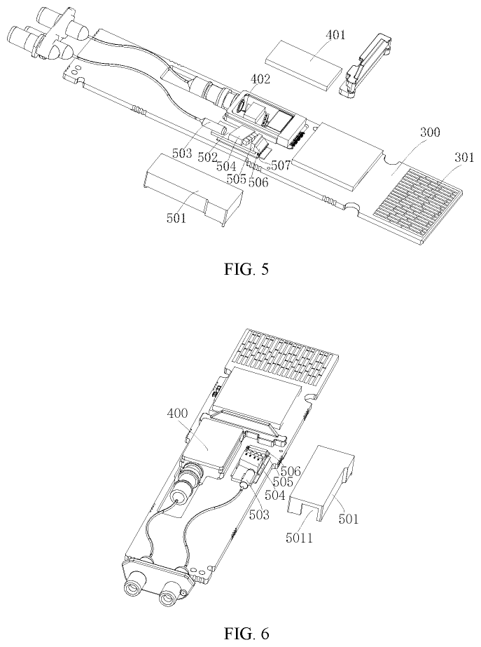

FIG. 6 is a second internal structural diagram of an optical module according to some embodiments of the present disclosure. As shown in FIG. 6, in some embodiments, a clearance groove 5011 is formed on one side of the cover 501 close to the second optical fiber adapter 503 to provide clearance for the second optical fiber adapter 503.

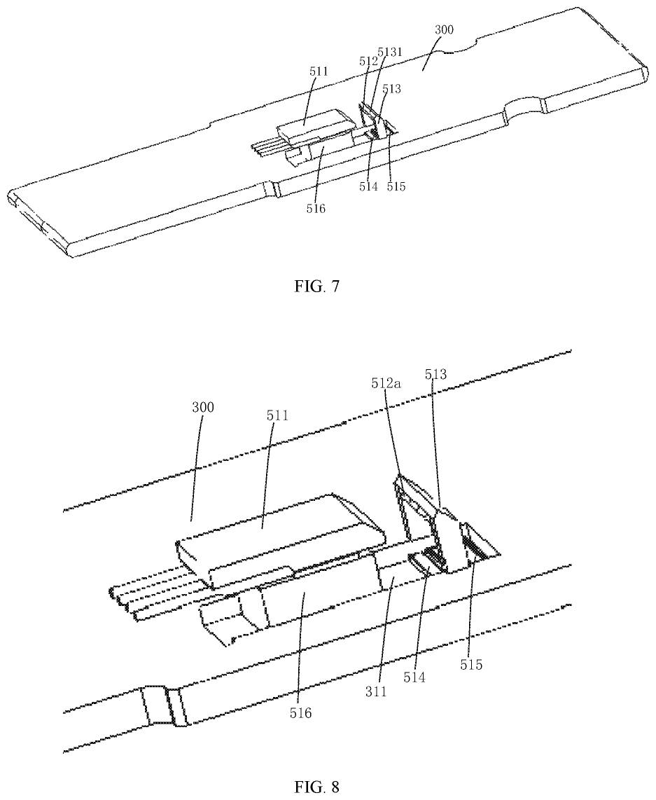

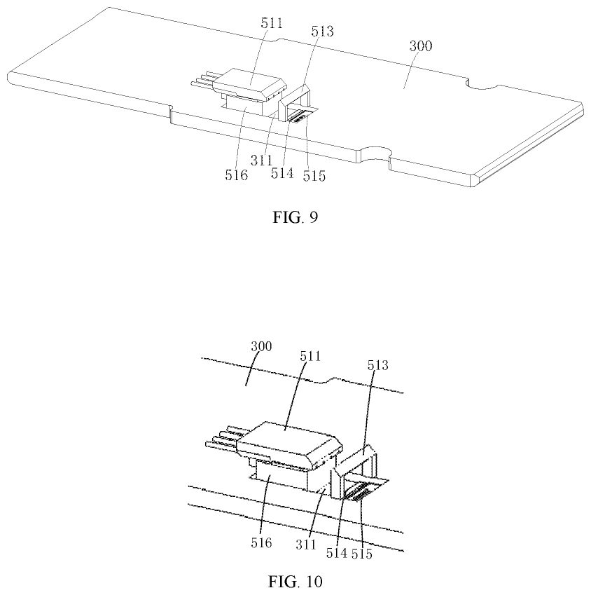

FIG. 7 is a first assembly diagram of an optical receiver component and a circuit board according to some embodiments of the present disclosure; FIG. 8 is a first structural diagram of an optical receiver component according to some embodiments of the present disclosure; FIG. 9 is a second assembly diagram of an optical receiver component and a circuit board according to some embodiments of the present disclosure; and FIG. 10 is a second structural diagram of an optical receiver component according to some embodiments of the present disclosure. As shown in FIG. 7 to FIG. 10, in some other embodiments of the present disclosure, the optical receiver component 500 includes an optical fiber array 511, a support frame 513, a converging and reflecting component array 512, and an optical receiver chip array 514.

In some embodiments, the optical fiber array 511 includes several receiving optical fibers to receive multiple optical signals. By way of example, when the optical module is a 400 G optical module, the optical fiber array 511 includes four receiving optical fibers; and when the optical module is an 800 G optical module, the optical fiber array 511 includes eight receiving optical fibers.

In some embodiments, the support frame 513 is disposed on one side of the optical fiber array 511, and the support frame 513 is configured to carry the converging and reflecting component array 512. The support frame 513 includes an inclined surface 5131. The converging and reflecting component array 512 is disposed on a surface of the inclined surface 5131. The inclined surface 5131 is disposed obliquely relative to the light output direction of the optical fiber array 511. The inclined surface 5131 has a certain distance from the surface of the circuit board 300. By way of example, the inclined surface 5131 is higher than the surface of the circuit board 300. The inclined surface 5131 has a preset inclination direction. One end of the inclined surface 5131 close to the optical fiber array 511 is higher than the other end (the end away from the optical fiber array 511). By way of example, the converging and reflecting component array 512 is located on the surface of the inclined surface 5131 facing the light output end surface of the optical fiber array 511.

In some embodiments, the converging and reflecting component array 512 is disposed on the surface of the inclined surface 5131. The converging and reflecting component array 512 includes several converging and reflecting components 512a. One converging and reflecting component 512a corresponds to one receiving optical fiber. An optical signal transmitted from the receiving optical fiber is incident on a surface of the converging and reflecting component, and then the converging and reflecting component 512a reflects and converges the optical signal. Curved surfaces are formed on the surfaces of the converging and reflecting components 512a facing the optical fiber array 511. The curved surfaces are functional surfaces and have both reflecting and converging functions. The curved surfaces are formed on the surfaces of the converging and reflecting components 512a. Since the converging and reflecting components 512a are disposed on the inclined surface, the curved surfaces are disposed obliquely and are inclined surfaces, such that the optical signals output from the optical fiber array can be reflected. In addition, the curved surfaces are recessed relative to the light output end surface of the optical fiber array, such that the curved surfaces can converge the reflected optical signals. Thus, the curved surfaces of the converging and reflecting components have both reflecting and converging functions. Since the curved surfaces have both reflecting and converging functions, the curved surfaces of the converging and reflecting components 512a can reflect the optical signals received by the optical fiber array 511 toward the optical receiver chips and converge the optical signals during reflection, such that the optical signals are focused on the photosensitive surfaces of the optical receiver chips.

In some embodiments, the optical receiver chip array 514 includes several optical receiver chips disposed below the inclined surface 5131. One optical receiver chip corresponds to one converging and reflecting component 512a to receive the optical signal output from the converging and reflecting component 512a. Since the converging and reflecting components 512a are disposed on the inclined surface, the curved surfaces of the converging and reflecting components 512a are disposed obliquely and face the optical fiber array 511. The curved surfaces reflect the optical signals output from the optical fiber array 511 toward the photosensitive surfaces of the optical receiver chip array 514, thereby achieving reception of the optical signals. In some embodiments, the optical receiver chip array 514 may also be a single optical receiver chip having a plurality of photosensitive surfaces, which can also achieve reception of multiple optical signals.

In some embodiments, the support frame 513 is configured to carry the converging and reflecting component array 512. The converging and reflecting component array 512 should be disposed above the optical receiver chip array 514, such that the inclined surface 5131 of the support frame 513 has a certain height from the surface of the circuit board 300. To ensure that an optical path of the optical fiber array 511 and an optical path of the converging and reflecting component array 512 are on the same plane, a spacer block 516 is disposed below the optical fiber array 511 to raise the optical path of the optical fiber array 511 and ensure that it is on the same plane as the optical path of the converging and reflecting component array 512.

In some embodiments, a transimpedance amplifier 515 is disposed on one side of the optical receiver chip array 514. The optical receiver chip is configured to convert the optical signal into an electrical signal, which is then converted into a voltage signal and amplified by the transimpedance amplifier 515.

In some embodiments, to reduce the overall height of the optical module, a groove 311 is formed in the surface of the circuit board 300. The spacer block 516, the optical receiver chip array 514, and the transimpedance amplifier 515 are all disposed on a surface of the groove 311. When the optical receiver chip array 514 and the transimpedance amplifier 515 are disposed on the surface of the groove 311, their surfaces can be flush with the surface of the circuit board 300, thereby shortening the wire bonding length between them and the circuit board 300, and helping to improve the performance of high-frequency signal transmission.

FIG. 11 is a schematic diagram of an optical path of an optical receiver component according to some embodiments of the present disclosure. As shown in FIG. 11, four optical signals output from the optical fiber array 511 are respectively transmitted to the surfaces of four converging and reflecting components. The converging and reflecting components reflect the optical signals toward the corresponding photosensitive surfaces of the optical receiver chip array 514, thereby achieving reception of the optical signals.

The converging and reflecting component 512a can deflect the optical path, thereby changing the transmission direction of the optical path, and adjusting the transmission direction of the optical path from parallel to the surface of the circuit board 300 to perpendicular to the surface of the circuit board 300. In addition, since the optical signals output from the optical fiber array 511 are divergent light, the converging and reflecting components 512a converge the optical signals while reflecting them, such that the light spots of the optical signals are focused on the photosensitive surfaces. According to the present disclosure, both reflection and convergence are performed on the surface of the converging and reflecting component 512a, thereby simplifying the optical path structure.

In the present disclosure, the converging and reflecting component 512a has both reflecting and converging functions, that is, it integrates the reflecting mirror and the converging lens, such that the reflecting mirror does not need to be additionally disposed between the optical fiber array 511 and the converging lens, thereby shortening the lateral distance between the optical fiber array 511 and the converging and reflecting component 512a, and making the optical component more compact.

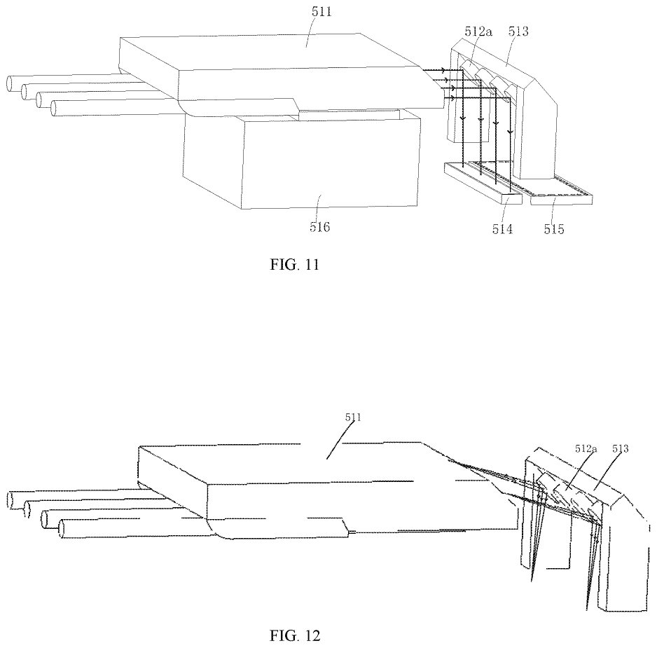

FIG. 12 is a schematic principle diagram of an optical path of a converging and reflecting component according to some embodiments of the present disclosure. As shown in FIG. 12, the curved surfaces are formed on the surfaces of the converging and reflecting components 512a. Since the converging and reflecting components 512a are disposed on the inclined surface 5131, the curved surfaces can reflect the optical signals output from the optical fiber array 511. In addition, the curved surfaces are recessed relative to the light output end surfaces of the optical fiber array 511, such that the curved surfaces can converge the reflected optical signals. In the present disclosure, since the curved surfaces have both reflecting and converging functions, the curved surfaces of the converging and reflecting components 512a can reflect the optical signals received by the optical fiber array 511 toward the optical receiver chips and converge the optical signals during reflection, such that the optical signals are focused on the photosensitive surfaces of the optical receiver chips. In the present disclosure, the curved surfaces of the converging and reflecting components 512a have both reflecting and converging functions, such that the reflecting mirror does not need to be additionally disposed on the output optical path of the optical fiber array, thereby simplifying the optical path structure, and making the structure more compact.

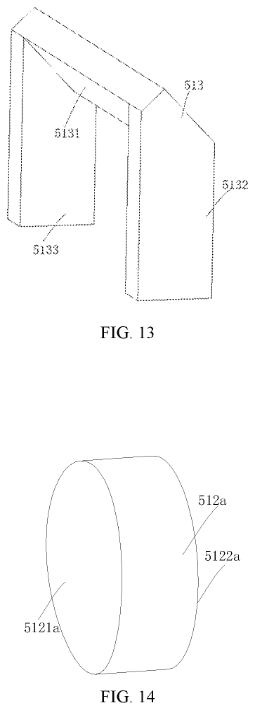

FIG. 13 is a structural diagram of a support frame according to some embodiments of the present disclosure. As shown in FIG. 13, in some embodiments, the support frame 513 includes a first side plate 5132, a second side plate 5133, and an inclined surface 5131. The first side plate 5132 and the second side plate 5133 are located on two side surfaces of the support frame, and the inclined surface 5131 is located at the top end of the support frame. The inclined surface 5131 is located between the first side plate 5132 and the second side plate 5133. The first side plate 5132 and the second side plate 5133 are configured to support the inclined surface 5131. The first side plate 5132 and the second side plate 5133 have a certain height to raise the inclined surface 5131 to a certain height, such that the converging and reflecting components 512a disposed on the inclined surface 5131 have a certain distance from the optical receiver chips, thereby enabling the converging and reflecting components 512a to converge the optical signals during reflection. The inclined surface 5131 faces the optical fiber array 511, and the inclined surface 5131 can provide a certain inclination angle for the converging and reflecting components 512a disposed thereon, thereby ensuring that the converging and reflecting components 512a can receive the optical signals output from the optical fiber array 511 and reflect the optical signals.

It should be noted that an inclined plate is disposed between the first side plate 5132 and the second side plate 5133, and the large surface of the inclined plate facing the optical fiber array 511 is the inclined surface 5131. To facilitate adjustment of the inclination degree of the inclined surface 5131, the inclined plate may be rotatably disposed between the first side plate 5132 and the second side plate 5133. The specific rotational connection may be riveting or the like, which is not limited herein.

FIG. 14 is a structural diagram of a converging and reflecting component according to some embodiments of the present disclosure. As shown in FIG. 14, in some embodiments, the converging and reflecting component array 512 includes converging and reflecting components 512a. The converging and reflecting component 512a includes a curved surface 5121a and a connecting surface 5122a disposed oppositely. Since the curved surfaces 5121a have both reflecting and converging functions, the curved surfaces 5121a can reflect the optical signals received from the optical fiber array 511 toward the optical receiver chips and converge the optical signals during reflection, such that the optical signals are focused on the photosensitive surfaces of the optical receiver chips. The connecting surface 5122a is fixedly connected to the inclined surface 5131, thereby fixing the converging and reflecting component 512a to the surface of the inclined surface 5131. The fixed connection between the connecting surface 5122a and the inclined surface 5131 may be adhesive bonding, snap-fit, threaded connection, or the like, which is not specifically limited herein.

In some embodiments, the converging and reflecting component 512a should have a certain magnification, such that the light spot formed by the optical signal is focused on the photosensitive surface of the optical receiver chip. Since a certain relationship exists between the magnification of the converging and reflecting component 512a and the effective focal length of the curved surface 5121a, the curved surface 5121a has a preset effective focal length to meet the magnification of the converging and reflecting component 512a, thereby finally focusing the light spot on the photosensitive surface of the optical receiver chip.

In some embodiments, a first preset distance is provided between the center of the curved surface 5121a and the light output end surface of the optical fiber array 511; and a second preset distance is provided between the center of the curved surface 5121a and the photosensitive surface of the optical receiver chip. The second preset distance is in a preset multiple relationship with the first preset distance to meet the magnification of the converging and reflecting component 512a, such that the light spot formed by the optical signal received by the optical receiver component 500 is focused on the photosensitive surface of the optical receiver chip.

In some embodiments, the converging and reflecting component 512a is configured as a freeform mirror, and thus the curved surface 5121a is a freeform surface. The freeform surface generally refers to an optical functional surface that cannot be represented by a spherical or aspheric coefficient or cannot be represented by an exact expression, and mainly refers to a non-rotationally symmetric functional surface or a functional surface that can only be represented by a parameter vector. Compared with the aspheric surface, the freeform surface has a greater degree of freedom, thereby enabling control over the exit angle and direction of each light ray as required.

By way of example, the curved surface 5121a is a Zernike standard sag surface.

The surface sag of the curved surface 5121a is given by:

$$z = \frac{c {r}^{2}}{1 + \sqrt{1 - ( 1 + k ) {c}^{2}} {r}^{2}} + {\sum }_{i = 1}^{8} {a}_{i} {r}^{2 i} + {\sum }_{i = 1}^{N} {A}_{i} {Z}_{i} ( ρ , φ ) \qquad ( 1 )$$

where c is a radius of curvature at a reference point, r is a radial coordinate of the light ray, k is a conic constant, aᵢ is a higher-order coefficient, Zᵢ(ρ,φ) is a Zernike polynomial, N is the total number of Zernike polynomials, Aᵢ is a coefficient of an i^{th} Zernike polynomial, ρ is a normalized radial coordinate, and φ is a normalized angular coordinate.

By way of example, when aᵢ is 0, the surface sag of the curved surface 5121a is given by:

$$z = \frac{c {r}^{2}}{1 + \sqrt{1 - ( 1 + k ) {c}^{2}} {r}^{2}} + {\sum }_{i = 1}^{N} {A}_{i} {Z}_{i} ( ρ , φ ) . \qquad ( 2 )$$

The curved surface 5121a is optimally designed according to the equation (2). By way of example, the radius of curvature at the reference point of the curved surface 5121a is −1.83 mm, and the conic constant thereof is 0.861. By way of example, the “reference point” in the radius of curvature at the reference point refers to the most concave point of the curved surface 5121a relative to the light output end surface of the optical fiber array 511.

It can be understood that when the above optical receiver component 500 including the converging and reflecting components and the above optical transmitter component 400 are disposed inside the same optical module, the emitting optical fibers of the optical transmitter component 400 adopt an emitting optical fiber array similar to the optical fiber array 511.

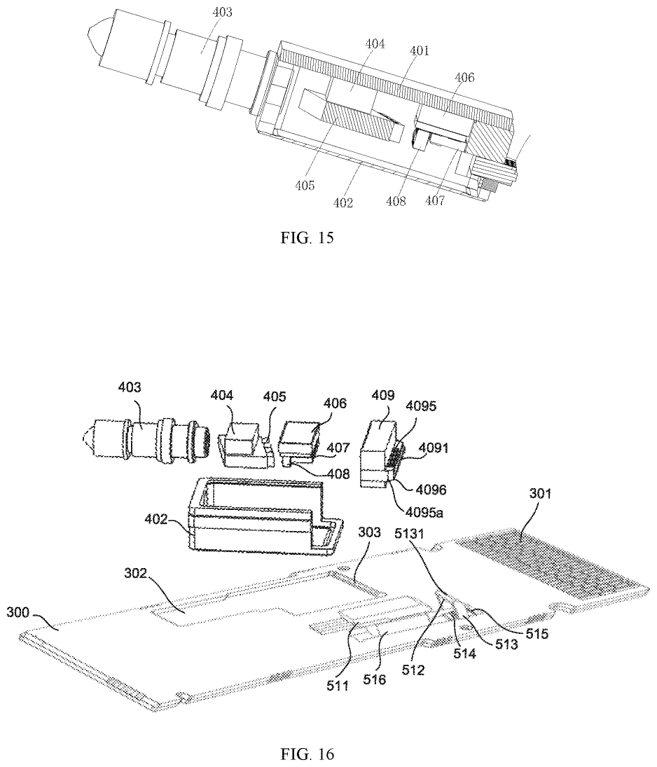

FIG. 15 is a structural diagram of an optical transmitter component according to some embodiments of the present disclosure; and FIG. 16 is an exploded view of an optical transmitter component according to some embodiments of the present disclosure. As shown in FIG. 15 and FIG. 16, in some embodiments, the optical transmitter component 400 includes a cover plate 401 and a tube housing 402. One end of the tube housing 402 is provided with a first optical fiber adapter 403. The first optical fiber adapter 403 is configured to transmit the optical signal generated by the optical transmitter component 400. A laser chip array, a lens 408, and an optical multiplexing assembly 405 are disposed inside the tube housing 402. The laser chip array includes several laser chips 407.

The laser chip 407 emits an optical signal in the form of a divergent beam, which is then converged by the lens 408 into a convergent beam. The laser chip array emits multiple optical signals, which are respectively incident into the optical multiplexing assembly 405. The optical multiplexing assembly 405 combines the multiple optical signals into one optical signal, which is then output via the first optical fiber adapter 403.

In some embodiments, a support block 404 is disposed between the cover plate 401 and the optical multiplexing assembly 405. One surface of the support block 404 is connected to the cover plate 401, and the other surface thereof is connected to the optical multiplexing assembly 405, thereby connecting the optical multiplexing assembly 405 to the cover plate 401. In this case, the optical multiplexing assembly 405 is closer to the upper shell 201, which is more conducive to heat dissipation of the optical multiplexing assembly 405. In addition, in some embodiments, the rigidity of the cover plate 401 is greater than that of the tube housing 402, such that connecting the optical multiplexing assembly 405 to the cover plate 401 is more conducive to enhancing the stability of the optical path.

In some embodiments, the optical transmitter component 400 further includes a thermo electric cooler (TEC) 406. One surface of the TEC 406 is connected to the cover plate 401, and the other surface thereof is configured to support the laser chip array and the lens 408. Similarly, in this case, the laser chip array and the lens 408 are closer to the upper shell 201, which is more conducive to heat dissipation of the laser chip array and the lens 408. In addition, in some embodiments, the rigidity of the cover plate 401 is greater than that of the tube housing 402, such that connecting the laser chip array and the lens 408 to the cover plate 401 is also conducive to enhancing the stability of the optical path.

In some embodiments, the optical transmitter component 400 further includes an electrical connector 409. The electrical connector 409 is disposed at an end of the tube housing 402, and the electrical connector 409 is configured to electrically connect the laser chip array to the circuit board 300.

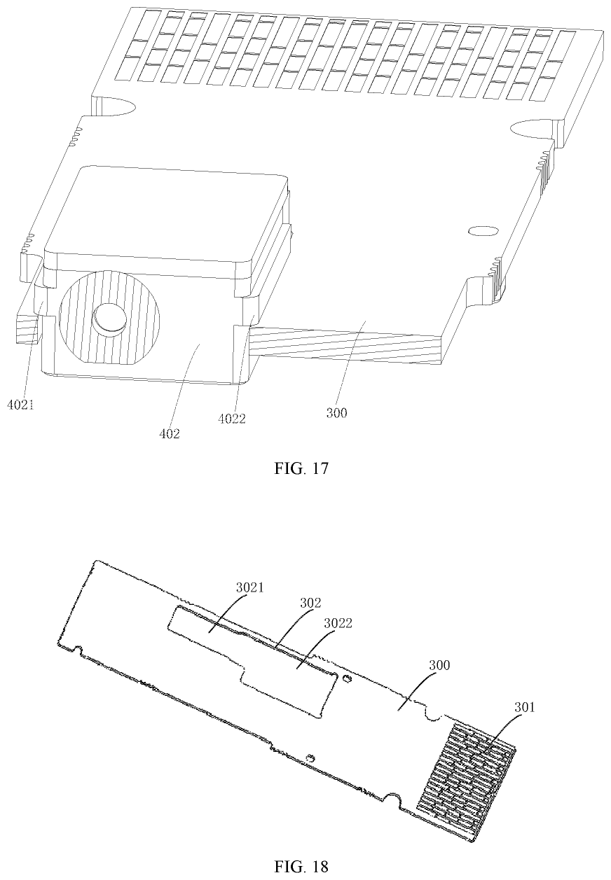

FIG. 17 is a schematic assembly diagram of an optical transmitter component and a circuit board according to some embodiments of the present disclosure. As shown in FIG. 17, in some embodiments, two sidewalls of the tube housing 402 respectively protrude to form a first overlapping portion 4021 and a second overlapping portion 4022. The first overlapping portion 4021 and the second overlapping portion 4022 respectively overlap on the surface of the circuit board 300, thereby achieving a connection between the optical transmitter component 400 and the circuit board 300.

FIG. 18 is a schematic structural diagram of a circuit board according to some embodiments of the present disclosure. As shown in FIG. 18, in some embodiments, a notch 302 is formed through the surface of the circuit board 300, and the first overlapping portion 4021 and the second overlapping portion 4022 of the tube housing 402 respectively overlap on a surface of the notch 302. The notch 302 includes a first notch portion 3021 and a second notch portion 3022. The first notch portion 3021 is configured to provide clearance for the first optical fiber adapter 403, and the second notch portion 3022 is configured to provide clearance for the tube housing 402. The first overlapping portion 4021 and the second overlapping portion 4022 respectively overlap on a surface of the second notch portion 3022 to place the optical transmitter component 400 in the notch of the circuit board, thereby achieving the connection between the optical transmitter component 400 and the circuit board 300.

In some embodiments, an intermediate structure of the tube housing 402 is fitted into the notch 302, and the upper surface of the tube housing 402 protrudes relative to the upper surface of the circuit board 300, that is, the upper surface of the tube housing 402 is exposed relative to the upper surface of the circuit board 300. Similarly, the lower surface of the tube housing 402 protrudes relative to the lower surface of the circuit board 300, that is, the lower surface of the tube housing 402 is exposed relative to the lower surface of the circuit board 300. Then, the first overlapping portion 4021 and the second overlapping portion 4022 of the tube housing 402 respectively overlap on the surface of the notch 302, thereby achieving a connection between the tube housing 402 and the circuit board 300.

It should be noted that to facilitate embedding of the tube housing 402 in the notch 302 of the circuit board 300 via the first overlapping portion 4021 and the second overlapping portion 4022, a limiting groove may be formed in a position of the circuit board 300 close to the notch 302. The shape of the limiting groove may be adapted to that of the first overlapping portion 4021 and/or the second overlapping portion 4022. Such an arrangement can also prevent the tube housing 402 from moving relative to the circuit board 300, thereby facilitating subsequent wire bonding between the optical transmitter component and the circuit board 300.

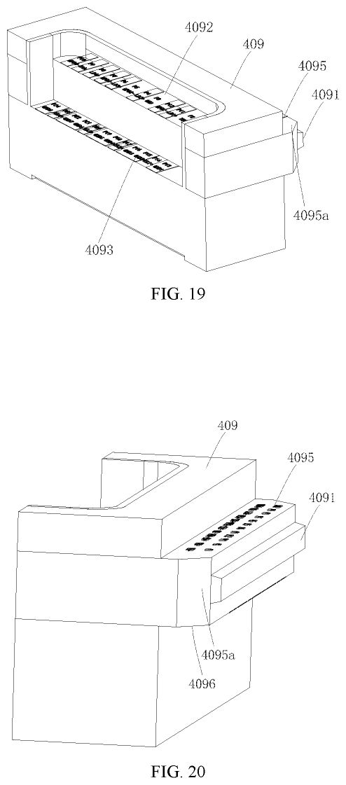

FIG. 19 is a first structural diagram of an electrical connector according to some embodiments of the present disclosure; and FIG. 20 is a second structural diagram of an electrical connector according to some embodiments of the present disclosure. As shown in FIG. 19 and FIG. 20, in some embodiments, one end of the electrical connector 409 extends into the tube housing 402, and the other end thereof is provided with a boss 4095a. The boss 4095a is located outside the tube housing 402.

A third metal region 4092 and a fourth metal region 4093 are respectively formed on the surface of the electrical connector 409 extending into the tube housing 402. One end of the third metal region 4092 and one end of the fourth metal region 4093 are respectively electrically connected to the laser chips. By way of example, the third metal region 4092 and the fourth metal region 4093 are disposed in a stepped manner. The third metal region 4092 is configured to transmit a high-frequency signal, and the fourth metal region 4093 is configured to transmit a low-frequency signal.

A first metal region 4095 and a second metal region 4096 are respectively formed on the upper surface and the lower surface of the boss 4095a. The first metal region 4095 is electrically connected to the other end of the third metal region 4092 and configured to transmit the high-frequency signal. The second metal region 4096 is electrically connected to the other end of the fourth metal region 4093 and configured to transmit the low-frequency signal.

The first metal region 4095 is flush with the upper surface of the circuit board 300, and the second metal region 4096 is flush with the lower surface of the circuit board 300. The first metal region 4095 is wire-bonded to the upper surface of the circuit board 300, and the second metal region 4096 is wire-bonded to the lower surface of the circuit board 300.

In some embodiments, when the optical module is inserted or removed, the circuit board deforms under force, causing relative displacement between the electrical connector 409 and the circuit board 300 due to lack of connection, thereby generating a certain pulling force on a gold wire and further resulting in breakage of the gold wire or the like. To enhance the stability of a connection between the electrical connector 409 and the circuit board 300, a second connecting portion is formed at one end of the boss 4095a facing the circuit board 300. Through interlocking engagement between the second connecting portion and a first connecting portion described below, the electrical connector 409 is retained on the circuit board 300, thereby enhancing the stability of the connection between the electrical connector 409 and the circuit board 300.

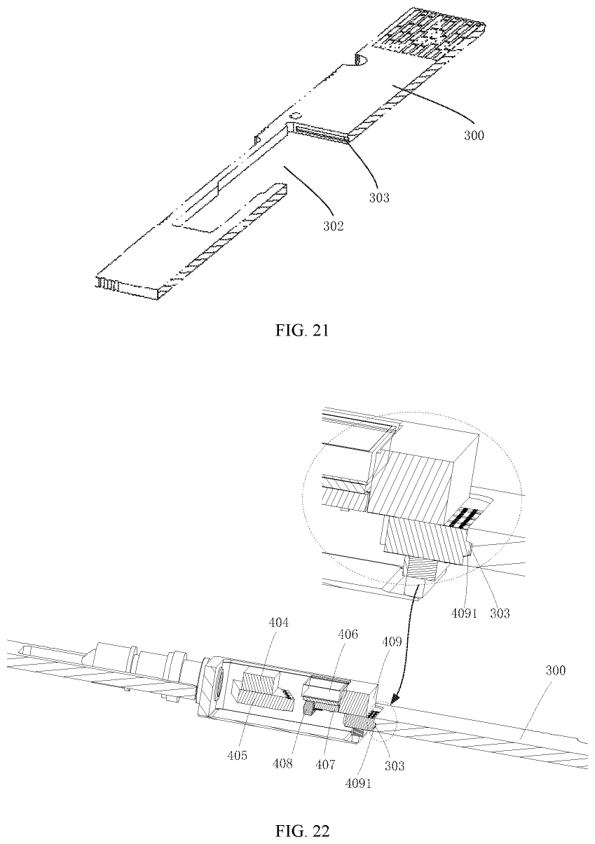

FIG. 21 is a schematic cross-sectional view of a circuit board according to some embodiments of the present disclosure; and FIG. 22 is an assembly cross-sectional view of an optical transmitter component and a circuit board according to some embodiments of the present disclosure. As shown in FIG. 21 and FIG. 22, in some embodiments, the circuit board 300 includes a notch 302, and a first connecting portion is formed on a sidewall of the notch 302. The first connecting portion is interlockingly engaged with the second connecting portion to achieve a relatively fixed connection between the electrical connector and the circuit board, thereby reducing relative displacement between the electrical connector and the circuit board during insertion or removal of the optical module, reducing the pulling force on the gold wire, preventing breakage of the gold wire, and ensuring the quality of high-frequency signal transmission. In addition, the fixed connection between the first connecting portion and the second connecting portion can ensure that the wire-bonding end surface of the electrical connector is flush with the wire-bonding end surface of the circuit board, thereby preventing misalignment of the wire-bonding end surfaces caused by other external forces, providing a relatively stable platform for wire bonding, and ensuring the quality of high-frequency signal transmission.

In some embodiments, the wire-bonding end surface of the electrical connector 409 and the wire-bonding end surface of the circuit board 300 may be displaced or pried due to processing tolerances, other external forces, etc., resulting in an unstable wire-bonding platform. When the second connecting portion is formed on the end surface of the electrical connector 409 and the first connecting portion is formed on the end surface of the circuit board 300, the relatively fixed connection between the first connecting portion and the second connecting portion can ensure that the wire-bonding end surface of the electrical connector is flush with the wire-bonding end surface of the circuit board, thereby preventing misalignment of the wire-bonding end surfaces caused by other external forces, providing a relatively stable platform for wire bonding, and ensuring the quality of high-frequency signal transmission.

In some embodiments of the present disclosure, the connection between the first connecting portion and the second connecting portion may be an interlocking engagement, and certainly, it may also be any other connection. When the first connecting portion is selectively interlockingly engaged with the second connecting portion, in some embodiments, the first connecting portion may be a protruding portion, and the second connecting portion may be a recessed portion; and in some embodiments, the first connecting portion may be a recessed portion, and the second connecting portion may be a protruding portion.

In some embodiments, since the circuit board 300 is made of a relatively soft material, if the first connecting portion formed on the sidewall of the notch 302 is a protruding portion, the protruding portion may have insufficient supporting force due to the soft material, making it unable to adequately support the end surface of the electrical connector 409, thereby reducing the stability of the connection between the circuit board 300 and the electrical connector 409. In some embodiments, in this case, to ensure the supporting force of the protruding portion formed on the sidewall of the notch 302, the corresponding thickness of the circuit board 300 and the protruding portion should be sufficiently large to provide adequate supporting force. Meanwhile, the hollowed-out size of the recessed portion on the end surface of the electrical connector 409 will be relatively large, which increases the processing difficulty of the circuit board 300 and the electrical connector 409. Based on the above considerations, the first connecting portion formed on the sidewall of the notch 302 is configured as a recessed portion 303, and the second connecting portion formed on the end surface of the electrical connector 409 is configured as a protruding portion 4091. The recessed portion 303 and the protruding portion 4091 form a mortise-and-tenon fit, thereby achieving the relatively fixed connection between the circuit board 300 and the electrical connector 409. By way of example, the recessed portion 303 is formed on one side of the notch 302 close to the gold finger 301. In other words, the recessed portion 303 is formed at the notch 302 where the electrical connector 409 is connected to the circuit board 300. Through interlocking engagement between the protruding portion disposed on the electrical connector 409 and the recessed portion, it can be further ensured that the wire-bonding end surface of the electrical connector is flush with the wire-bonding end surface of the circuit board, thereby preventing misalignment of the wire-bonding end surfaces caused by other external forces.

In some embodiments, the protruding portion 4091 is fitted into the recessed portion 303 to achieve the relatively fixed connection between the electrical connector 409 and the circuit board 300, thereby reducing relative displacement between the electrical connector 409 and the circuit board 300 during insertion and removal of the optical module, reducing the pulling force on the gold wire, preventing breakage of the gold wire, and ensuring the quality of high-frequency signal transmission. In addition, the fixed connection between the recessed portion 303 and the protruding portion 4091 can ensure that the wire-bonding end surface of the electrical connector 409 is flush with the wire-bonding end surface of the circuit board 300, thereby preventing misalignment of the wire-bonding end surfaces caused by other external forces, providing a relatively stable platform for wire bonding, and ensuring the quality of high-frequency signal transmission.

In some embodiments, the protruding portion 4091 is configured as a flange, and the recessed portion 303 is configured as a groove, with the two in a concave-convex fit. The protruding portion 4091 matches the recessed portion 303 in shape. By way of example, both the protruding portion 4091 and the recessed portion 303 are trapezoidal in shape, and certainly, they may also be of other shapes.

In some examples, the second connecting portion formed on the end surface of the electrical connector 409 may be a U-shaped clamping jaw structure, and the second connecting portion formed at the notch of the circuit board 300 may be a positioning slot. The positioning slot is in communication with the notch. More specifically, the positioning slot is formed in the upper and lower surfaces of the circuit board 300. Accordingly, two jaw arms of the clamping jaw structure are disposed one above the other. The clamping jaw structure can extend into the positioning slot, thereby relatively fixing the electrical connector 409 to the circuit board 300. This ensures that the wire-bonding end surface of the electrical connector 409 is flush with the wire-bonding end surface of the circuit board 300, thus preventing misalignment of the wire-bonding end surfaces caused by other external forces.

In addition, to prevent the clamping jaw structure from affecting wire bonding between the electrical connector 409 and the circuit board 300, the clamping jaw structure may be disposed on an edge of the boss of the electrical connector 409. To further ensure the relative stability between the electrical connector 409 and the circuit board 300, a U-shaped clamping jaw structure may be disposed on each of two side edges of the boss. The number and positions of positioning slots formed in the notch may be set based on the number and positions of clamping jaw structures, and will not be repeated herein.

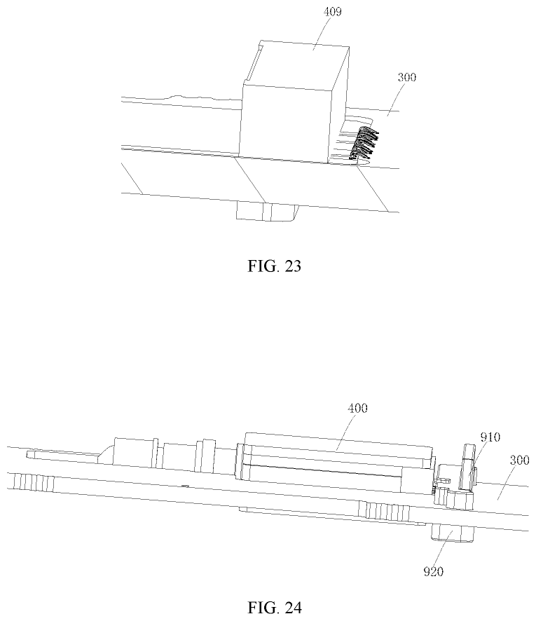

FIG. 23 is a schematic diagram of a bonding wire between an electrical connector and a circuit board according to some embodiments of the present disclosure. As shown in FIG. 23, the first metal region 4095 is flush with the upper surface of the circuit board 300, and the second metal region 4096 is flush with the lower surface of the circuit board 300. The first metal region 4095 is wire-bonded to the upper surface of the circuit board 300, and the second metal region 4096 is wire-bonded to the lower surface of the circuit board 300.

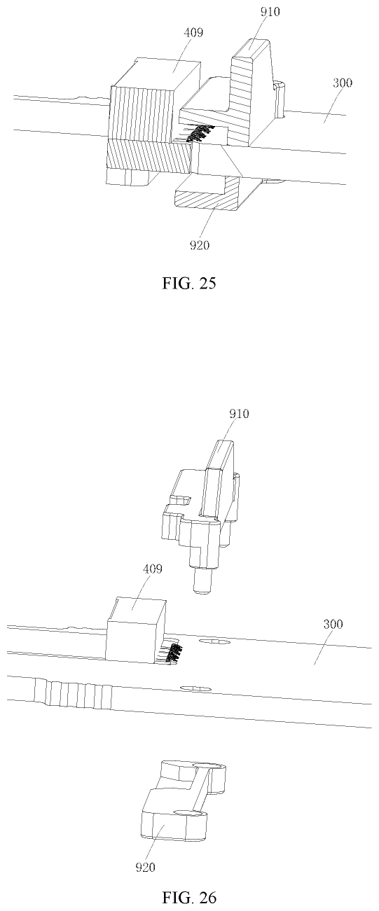

FIG. 24 is an assembly diagram of a first protective cover and a second protective cover according to some embodiments of the present disclosure; FIG. 25 is a cross-sectional view of a first protective cover and a second protective cover according to some embodiments of the present disclosure; and FIG. 26 is an exploded view of a first protective cover and a second protective cover according to some embodiments of the present disclosure. As shown in FIG. 24 to FIG. 26, a bonding wire between the first metal region 4095 and the upper surface of the circuit board 300 is covered by the first protective cover 910, thereby protecting the bonding wire between the first metal region 4095 and the upper surface of the circuit board 300, and providing dustproof and protective effects for the bonding wire. A bonding wire between the second metal region 4096 and the lower surface of the circuit board 300 is covered by the second protective cover 920, thereby protecting the bonding wire between the second metal region 4096 and the lower surface of the circuit board 300, and likewise providing dustproof and protective effects for the bonding wire.

In some embodiments, a through hole is formed in the surface of the circuit board 300 to connect the first protective cover 910 to the second protective cover 920. By way of example, the first protective cover 910 passes through the through hole and is connected to the second protective cover 920.

It can be understood that when the above optical receiver component 500 including the converging and reflecting components and the above optical transmitter component 400 with the electrical connector in mortise-and-tenon connection with the circuit board are disposed inside the same optical module, the emitting optical fibers of the optical transmitter component 400 adopt an emitting optical fiber array similar to the optical fiber array 511.

In the optical module according to the present disclosure, the first connecting portion is formed on the sidewall of the notch, and the second connecting portion is formed on the end surface of the boss facing the circuit board. The first connecting portion is interlockingly engaged with the second connecting portion to achieve the relatively fixed connection between the electrical connector and the circuit board, thereby reducing relative displacement between the electrical connector and the circuit board during insertion and removal of the optical module, reducing the pulling force on the gold wire, preventing breakage of the gold wire, and ensuring the quality of high-frequency signal transmission. In addition, the fixed connection between the first connecting portion and the second connecting portion can ensure that the wire-bonding end surface of the electrical connector is flush with the wire-bonding end surface of the circuit board, thereby preventing misalignment of the wire-bonding end surfaces caused by other external forces, providing a relatively stable platform for wire bonding, and ensuring the quality of high-frequency signal transmission.

The above descriptions are merely specific embodiments of the present disclosure, but the scope of protection of the present disclosure is not limited thereto. Any of those skilled in the art can think of changes or substitutions within the technical scope of the present disclosure, and these changes or substitutions shall all be included within the scope of protection of the present disclosure. Therefore, the scope of protection of the present disclosure shall be subject to the scope of protection of the claims.

What is claimed is:

1. An optical module, comprising:
a circuit board, wherein a notch is formed on a surface of the circuit board, and a first connecting portion is formed on a sidewall of the notch;
an optical transmitter component, comprising:
a tube housing, overlapping on a surface of the notch; and
an electrical connector, disposed at an end of the tube housing, wherein one end of the electrical connector extends into the tube housing, the other end of the electrical connector is provided with a boss, the boss is located outside the tube housing, a first metal region and a second metal region are respectively formed on an upper surface and a lower surface of the boss, the first metal region is flush with an upper surface of the circuit board, the second metal region is flush with a lower surface of the circuit board, the first metal region is wire-bonded to the upper surface of the circuit board, the second metal region is wire-bonded to the lower surface of the circuit board, a second connecting portion is formed on an end surface of the boss facing the circuit board, and the second connecting portion is interlockingly engaged with the first connecting portion to achieve a relatively fixed connection between the electrical connector and the circuit board; and
an optical receiver component, disposed on the surface of the circuit board, and comprising:
an optical fiber array, comprising several receiving optical fibers, and configured to receive multiple optical signals; and
a converging and reflecting component array, disposed on one side of the optical fiber array, and comprising several converging and reflecting components, wherein one of the converging and reflecting components corresponds to one of the receiving optical fibers, curved surfaces are formed on surfaces of the converging and reflecting components, the curved surfaces are recessed relative to a light output end surface of the optical fiber array, and the curved surfaces are configured to reflect the optical signals output from the optical fiber array and converge the reflected optical signals.

2. The optical module according to claim 1, wherein a first protective cover is disposed on the upper surface of the circuit board to protect a bonding wire between the first metal region and the upper surface of the circuit board;
a second protective cover is disposed on the lower surface of the circuit board to protect a bonding wire between the second metal region and the lower surface of the circuit board; and
the first protective cover passes through the surface of the circuit board to be fixedly connected to the second protective cover.

3. The optical module according to claim 1, wherein two sidewalls of the tube housing respectively protrude to form a first overlapping portion and a second overlapping portion, and the first overlapping portion and the second overlapping portion respectively overlap on the surface of the notch to achieve a connection between the tube housing and the circuit board.

4. The optical module according to claim 3, wherein an upper surface of the tube housing protrudes relative to the upper surface of the circuit board; and a lower surface of the tube housing protrudes relative to the lower surface of the circuit board.

5. The optical module according to claim 1, wherein the optical transmitter component further comprises:
a cover plate, connected to the tube housing in a covering manner;
a first optical fiber adapter, connected to one end of the tube housing;
a laser chip array, comprising laser chips, and configured to emit multiple optical signals;
a lens array, comprising lenses that correspond to the laser chips and are configured to converge the optical signals; and
an optical multiplexing assembly, optically connected to the optical fiber adapter, and configured to combine the multiple optical signals into one optical signal and transmit the optical signal into the optical fiber adapter.

6. The optical module according to claim 5, wherein the notch of the circuit board comprises a first notch portion and a second notch portion, the first notch portion is configured to provide clearance for the first optical fiber adapter, and the second notch portion is configured to provide clearance for the tube housing.

7. The optical module according to claim 5, wherein the optical transmitter component further comprises:
a support block, having one surface connected to the cover plate and the other surface connected to the optical multiplexing assembly, and configured to connect the cover plate to the optical multiplexing assembly; and
a thermo electric cooler (TEC), having one surface connected to the cover plate and the other surface configured to respectively support the laser chip array and the lens array.

8. The optical module according to claim 7, wherein the rigidity of the cover plate is greater than the rigidity of the tube housing.

9. The optical module according to claim 5, wherein
a third metal region and a fourth metal region are formed on a surface of the electrical connector extending into the tube housing; and
one end of the third metal region and one end of the fourth metal region are respectively electrically connected to the laser chips.

10. The optical module according to claim 9, wherein
the other end of the third metal region is electrically connected to the first metal region and configured to transmit a high-frequency signal; and
the other end of the fourth metal region is electrically connected to the second metal region and configured to transmit a low-frequency signal.

11. The optical module according to claim 1, wherein the first connecting portion is a recessed portion, and the second connecting portion is a protruding portion.

12. The optical module according to claim 11, wherein the circuit board is provided with a gold finger, and the recessed portion is formed on one side of the notch close to the gold finger.

13. The optical module according to claim 11, wherein the recessed portion and the protruding portion form a mortise-and-tenon fit.

14. The optical module according to claim 1, wherein the optical receiver component further comprises
an optical receiver chip array, comprising several optical receiver chips; and one of the optical receiver chips corresponds to one of the converging and reflecting components to receive the optical signal output from the converging and reflecting component.

15. The optical module according to claim 14, wherein a first preset distance is provided between a center of each of the curved surfaces and the light output end surface of the optical fiber array; and a second preset distance is provided between the center of each of the curved surfaces and a photosensitive surface of each of the optical receiver chips, and the second preset distance is in a preset multiple relationship with the first preset distance.

16. The optical module according to claim 14, wherein a transimpedance amplifier is disposed on one side of the optical receiver chip array, and the transimpedance amplifier is configured to convert electrical signals output from the optical receiver chips into voltage signals and amplify the voltage signals.

17. The optical module according to claim 16, wherein a spacer block is disposed below the optical fiber array, such that an optical path of the optical fiber array and an optical path of the converging and reflecting component array are on a same plane.

18. The optical module according to claim 17, wherein a groove is formed in the surface of the circuit board, and the spacer block, the optical receiver chip array, and the transimpedance amplifier are disposed on a surface of the groove.

19. The optical module according to claim 1, wherein the converging and reflecting components are configured as freeform mirrors.

20. The optical module according to claim 19, wherein the curved surfaces are Zernike standard sag surfaces, and surface sag of each of the curved surfaces is given by:
$$z = \frac{c {r}^{2}}{1 + \sqrt{1 - ( 1 + k ) {c}^{2}} {r}^{2}} + {\sum }_{i = 1}^{8} {a}_{i} {r}^{2 i} + {\sum }_{i = 1}^{N} {A}_{i} {Z}_{i} ( ρ , φ ) \qquad ( 1 )$$
wherein c is a radius of curvature at a reference point, r is a radial coordinate of a light ray, k is a conic constant, aᵢ is a higher-order coefficient, Zᵢ(ρ,φ) is a Zernike polynomial, N is the total number of Zernike polynomials, Aᵢ is a coefficient of an i^{th} Zernike polynomial, ρ is a normalized radial coordinate, and φ is a normalized angular coordinate.
